(19) United States
(12) Patent Application Publication
(10) Pub. No.: US 2019/0204998 A1
(43) Pub. Date: Jul. 4, 2019

(54) AUDIO BOOK POSITIONING

(71) Applicant: Google LLC, Mountain View, CA (US)

(72) Inventors: Greg Don Hartrell, Pleasanton, CA (US); Brady Duga, Carlsbad, CA (US); Alan Newberger, San Francisco, CA (US); Christopher Salvarani, Mountain View, CA (US); Garth Conboy, La Jolla, CA (US); John Rivlin, Palo Alto, CA (US); Andrew Casey Brown, New York, NY (US)

(21) Appl. No.: 15/873,839

(22) Filed: Jan. 17, 2018

Related U.S. Application Data
(60) Provisional application No. 62/612,176, filed on Dec. 29, 2017.

(51) Int. Cl. G06F 3/0483; G10L 15/26; G06F 3/16

(52) U.S. Cl. CPC G06F 3/0483; G10L 25/78; G06F 3/167; G10L 15/265

(57) ABSTRACT

An audio book server may identify, from a plurality of electronic texts, an electronic text that corresponds with an audio book. The audio book server may determine, based at least in part on the electronic text, organizational data associated with a plurality of time-based locations of the audio book. The audio book server may output the audio book and the organizational data to a remote computing device.

### RELATED APPLICATION

This application claims the benefit of U.S. Provisional Patent Application No. 62/612,176, filed Dec. 29, 2017, the entire content of which is hereby incorporated by reference.

### BACKGROUND

An audio book may be narrative audio, such as spoken narration of books, podcasts, plays, and the like, which is read aloud by a narrator. A listener may listen to narrative audio in lieu of reading the text version of such narrative audio. While text versions of narrative audio may include information such as a table of contents, an index, and the like, narrative audio often lack such organizational information.

### SUMMARY

In general, this disclosure describes techniques for determining organizational data associated with audio books as well as techniques for utilizing the organizational data to enhance the capabilities of an audio book player that plays audio books. The audio books may not include any organizational data, or may only include rudimentary organizational data. The techniques disclosed herein may identify electronic texts, such as eBooks, that correspond to audio books, and may align the identified electronic texts with the audio books to determine from the electronic texts organizational data associated with the audio books, and to associate such organizational data with specific locations within the audio book.

In one example, the disclosure is directed to a method. The method includes identifying, by at least one processor and from a plurality of electronic texts, an electronic text that corresponds with an audio book. The method further includes determining, by the at least one processor and based at least in part on the electronic text, organizational data associated with a plurality of time-based locations of the audio book. The method further includes outputting, by the at least one processor, the audio book and the organizational data to a remote computing device.

In another example, the disclosure is directed to a computing system. The computing system includes a computer-readable storage medium. The computing system further includes at least one processor operably coupled to the computer-readable storage medium and configured to: identify, from a plurality of electronic texts, an electronic text that corresponds with an audio book; determine, based at least in part on the electronic text, organizational data associated with a plurality of time-based locations of the audio book; and output the audio book and the organizational data to a remote computing device.

In another example, the disclosure is directed to a method. The method includes initiating, by at least one processor, playback of an audio book, wherein a plurality of time-based locations of the audio book are associated with organizational data that is determined based at least in part on an electronic text, out of a plurality of electronic texts, identified as corresponding with the audio book. The method further includes responsive to the playback of the audio book reaching one of the plurality of time-based locations of the audio book associated with the organizational data, outputting, by the at least one processor for display at a display device, information indicated by the organizational data.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system in which a computing device accesses audio books and data associated with the audio books from an audio book server, in accordance with one or more aspects of the present disclosure.

FIG. 2 is a block diagram illustrating an example computing device that is configured to receive and play back audio books, in accordance with one or more aspects of the present disclosure.

FIG. 3 is a block diagram illustrating an example audio book server, in accordance with one or more aspects of the present disclosure.

FIG. 4 is a flow diagram illustrating example operations of an audio book server that determines organizational data associated with audio books, in accordance with one or more techniques of the present disclosure.

FIG. 5 is a flow diagram illustrating example operations of a computing device that plays audio books received from an audio book server, in accordance with one or more techniques of the present disclosure.

### DETAILED DESCRIPTION

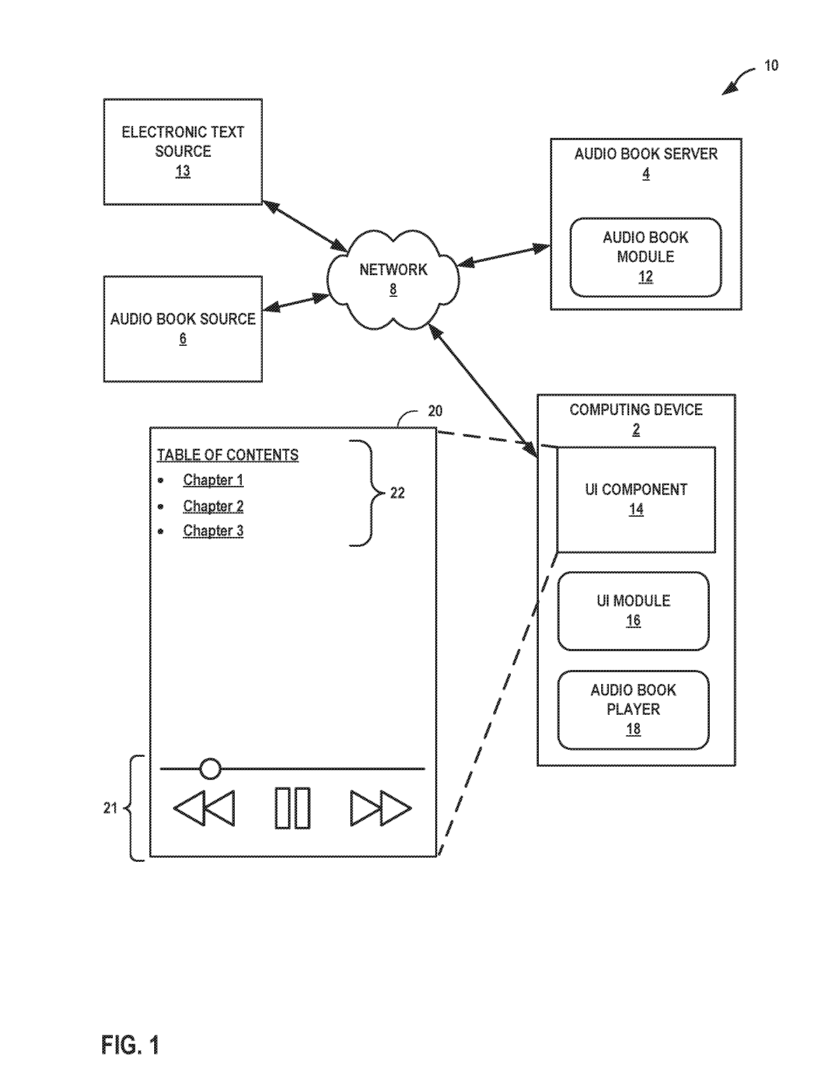

FIG. 1 is a conceptual diagram illustrating an example system in which a computing device 2 accesses audio books and data associated with the audio books from an audio book server 4, in accordance with one or more aspects of the present disclosure. System 10 of FIG. 1 includes audio book server 4 in communication, via one or more networks 8, with computing device 2, electronic text source 13, and audio book source 6. Although system 10 is shown as being distributed amongst computing device 2, audio book server 4, audio book source 6, and electronic text source 13, in other examples, the features and techniques attributed to audio book server 4 may be performed internally, such as by computing device 2. Similarly, audio book server 4 may include certain components and perform various techniques that are otherwise attributed in the below description to computing device 2, audio book source 6, and/or electronic text source 13.

Computing device 2 may communicate with audio book server 4 via one or more networks 8 to access audio books and data associated with such audio books. Similarly, audio book server 4 may communicate with audio book source 6 and electronic text source 13 via one or more networks 8 to access audio books from audio book source 6 and to access electronic texts associated with the audio books from electronic text source 13. One or more networks 8 represents any public or private communications network, for instance, cellular, Wi-Fi, and/or other types of wired and/or wireless networks, for transmitting data between computing systems, servers, and computing devices.

Audio book server 4 may exchange data, such as audio books and data associated with such audio books, via one or more networks 8, with computing device 2 to provide computing device 2 with audio books and data associated with audio books when computing device 2 is connected to one or more networks 8. Similarly, electronic text source 13 may exchange data, such as electronic texts associated with audio books, via one or more networks 8, with audio book server 4 to provide audio book server 4 with the electronic texts, and audio book source 6 may exchange data, such as audio books, via one or more networks 8, with audio book server 4 to provide audio book server 4 with audio books.

One or more networks 8 may include one or more network hubs, network switches, network routers, or any other network equipment, that are operatively inter-coupled thereby providing for the exchange of information between computing device 2, audio book server 4, audio book source 6, and text source 13. Computing device 2, audio book server 4, audio book source 6, and text source 13 may transmit and receive data across one or more networks 8 using any suitable communication techniques. Computing device 2, audio book server 4, audio book source 6, and text source 13 may each be operatively coupled to one or more networks 8 using respective network links. The links coupling computing device 2, audio book server 4, audio book source 6, and text source 13 to one or more networks 8 may be Ethernet or other types of network connections and such connections may be wireless and/or wired connections.

An audio book may be audio data that includes spoken audio of a text being read. For example, an audio book may be a recording of a book, an article, a magazine, and portions thereof, being read out loud by a person, a machine (e.g., text-to-speech software executing on a computer), and combinations thereof. An electronic text associated with an audio book may be a textual version of what is being read in the associated audio book. For example, the electronic text may be an electronic copy of the book, article, or magazine being read in the audio book. The electronic text associated with an audio book may contain organizational information associated with a corresponding audio book, not necessarily be an exact word-by-word match with a text transcript of a corresponding audio book.

Audio book source 6 may represent any suitable remote computing system such as one or more mainframes, web servers, cluster computing systems, physical server systems, virtual server systems, cloud computing systems, and the like capable of sending and receiving information both to and from a network, such as one or more networks 8. Audio book source 6 may be configured store and transmit machine readable data representing books in an audio format. Such books in audio formats may be referred to as an audio book. The term “audio book” as used throughout this disclosure may refer to any narrative audio recording, including but not limited to recorded books, podcasts, performances, lectures, songs, musicals, plays, and the like. Examples of audio book formats include: include MPEG-1 Audio Layer III or MPEG-2 Audio Layer III (MP3), Windows Media Audio (WMA), Advanced Audio Coding (AAC), and the like.

Electronic text source 13 may represent any suitable remote computing system such as one or more mainframes, web servers, cluster computing systems, physical server systems, virtual server systems, cloud computing systems, and the like capable of sending and receiving information both to and from a network, such as one or more networks 8. Electronic text source 13 may be configured to store and transmit machine readable data representing written works, such as books, magazines, publications, lyrics, scripts, and the like in a textual format. Such books in textual formats may be referred to as an electronic book, an eBook, electronic text, and the like. Examples of textual formats of books stored in electronic text source 13 may include plain text, Hypertext Markup Language (HTML), Portable Document Format (PDF), ePub, and the like.

While electronic text source 13 and audio book source 6 are shown in the example of FIG. 1 as separate systems, it should be understood that, in some examples, text source 13 and audio book source 6 may be a part of the same system. In some examples, the textual and audio formats of a book may be stored together by audio book source 6 and/or electronic text source 13 in a combined format, such as an ePub, that includes both the textual and audio formats of a book in a single file.

Audio book server 4 may represent any suitable server system, such as one or more mainframes, web servers, cluster computing systems, physical server systems, virtual server systems, and the like capable of sending and receiving information both to and from a network, such as one or more networks 8. In some examples, audio book server 4 may represent cloud computing systems and/or platforms that provide access to their respective services via a cloud.

Audio book server 4 may be configured to receive audio books from audio book source 6 and to determine organizational data associated with each of the audio books. Upon receiving a request from computing device 2 for an audio book, audio book server 4 may transmit to computing device 2 the audio book as well as organizational data associated with the audio book.

Organizational data associated with the audio book may be contextual data associated with the audio book. For example, organizational data may indicate the intended written structure of the spoken words in the audio book, including but not limited to sentences, paragraphs, chapters, and the like. Organizational data may also indicate information associated with particular locations within the audio book. Examples of such information associated with locations within the audio book may include the character that is currently speaking at a particular location in the audio book, a definition of the word being spoken at a particular location in the audio book, and the like. By determining the organizational data associated with the audio book, and by transmitting the organizational data associated with an audio book along with the audio book to computing device 2, audio book server 4 may enable computing device 2 to improve the navigation of the audio book as well as to improve the user experience of interacting with computing device 2 to listen to the audio book.

In the example of FIG. 1, audio book server 4 includes audio book module 12. Audio module 12 may perform operations described herein using software, hardware, firmware, or a mixture of hardware, software, and firmware residing in and/or executing at audio book server 4. Audio book server 4 may execute audio book module 4 with multiple processors or multiple devices. Audio book server 4 may execute audio book module 12 as virtual machines executing on underlying hardware, as one or more services of an operating system or computing platform, and/or as one or more executable programs at an application layer of a computing platform.

Audio book module 12 may be configured to receive audio books from audio book source 6 and to determine organizational data associated with each of the receive audio books. For example, audio book module 12 may maintain a library of available audio books that may be accessed by computing device 2, and may update the library of available audio books when ingesting audio books from audio book source 6. Audio book module 12 may transmit an indication of the available audio books in its library to computing device 2 so that computing device 2 is able to access the audio books in the library.

When audio book module 12 receives an audio book from audio book source 6, audio book module 12 may determine organizational data associated with the audio book. As part of determining the organizational data associated with the audio book, audio book module 12 may perform speech recognition (e.g., speech-to-text conversion) on the speech contents of the audio book to generate a text transcript of the audio book. For example, audio book module 12 may transcode the audio data of the audio book and extract the raw audio of the audio book. Audio book module 12 may perform speech recognition (e.g., speech-to-text) on the extracted raw audio of the audio book to extract a text transcript of the audio book.

In some examples, audio book module 12 may divide the raw audio into a plurality of portions, such as by cutting the raw audio within inferred silence intervals. Audio book module 12 may perform speech recognition of each of the plurality of portions of the raw audio in parallel (e.g., at about the same time) to generate a plurality of recognized portions of the raw audio. Audio book module 12 may concatenate the plurality of recognized portions of the raw audio into a text transcript of the audio book.

In some examples, audio book module 12 may use metadata associated with or contained in the audio book in performing speech recognition of the audio book. For example, the audio book may contain or may otherwise be associated with metadata that indicates the language of the speech contents of the audio book. Audio book module 12 may utilize the indication of the language of the speech contents of the audio book to select an appropriate language model to be used in performing speech recognition of the audio book.

In addition to, or as an alternative to performing speech recognition to extract a text transcript of the audio book, audio book module 12 may determine whether electronic text that corresponds with the audio book is available. An electronic text that corresponds with an audio book may be an eBook, electronic transcript, or other text document in electronic form that contains textual content which corresponds to the spoken content of the audio book. For example, if the audio book is a spoken version of a book, then the electronic text that corresponds with the audio book may be a written version of the same book. In another example, if the audio book is an audio version of the performance of a play, then the electronic text that corresponds with the audio book may be the script of the play. As discussed above, an electronic text that corresponds with the audio book may not necessarily be a word-by-word transcription of the audio book. For example, the electronic text may be a different version of the book, an unabridged version of an abridged audio book, and the like, or the electronic book may include a preface or acknowledgements that are not in the audio book.

Audio book module 12 may query and/or search electronic text source 13 for electronic text that corresponds with the audio book. Audio book module 12 may identify an electronic text that corresponds with the audio book based at least in part on one or more of: metadata, human curation, and/or automated detection. For example, an audio book may include or be associated with metadata that identifies the electronic text that corresponds with the audio book, or an electronic text may include or be associated with metadata that identifies the audio book with which the electronic text corresponds. In another example, a human can identify an electronic text in electronic text source 13 that corresponds with the audio book.

Audio book module 12 may also perform automated detection of an electronic text that corresponds with the audio book. In particular, audio book module 12 may perform speech recognition on the audio book to generate a text transcript of the audio book, and may determine an electronic text that most closely matches the text transcript of the audio book out of the electronic texts in electronic text source 13. In one example, audio book module 12 may compare electronic texts, or selected portions of the electronic texts, word-by-word with the text transcript of the audio book or portions thereof to determine the electronic text that has the closest word-by-word similarity with the text transcript of the audio book out of the electronic texts in electronic text source 13. In another example, audio book module 12 may perform automated detection of an electronic text that corresponds with the audio book by breaking an electronic text up into shingles and using MinHash to determine an electronic text that is most similar to the text transcript of the audio book.

Upon determining an electronic text that corresponds with the audio book, audio book module 12 may extract the text from the electronic text, key features of the text, such as words, sentences, chapters, and paragraphs, as well as the position of such key features in the text. For example, audio book module 12 may extract the table of contents of the electronic text and may determine the locations within the electronic text to which the table of contents point, such as the positions in the electronic text of each of the chapters.

The electronic text that corresponds with the audio book may not necessarily be a word-by-word match with the text transcript of the audio book due to many reasons. For example, the electronic text may be a different edition or version of the book than the audio book, or the audio book may contain rhetorical flourishes by the narrator that is not present in the electronic text. Thus, one or more portions of the electronic text may match one or more corresponding portions of the text transcript, while one or more portions of the electronic text may not match one or more corresponding portions of the text transcript.

Audio book module 12 may align the electronic text with the text transcript of the audio book to determine one or more portions of the audio book that are aligned with one or more portions of the electronic text. A portion of the electronic text may be aligned with a corresponding portion of the audio book if there is a close match between the portion of the electronic text and the text transcript of the portion of the audio book. Conversely, a portion of the electronic text may not be aligned with a corresponding portion of the audio book if there is not a close match between the portion of the electronic text and the text transcript of the portion of the audio book.

Aligning the electronic text with the text transcript may include determining a correspondence between textual strings (e.g., words, sentences, paragraphs, chapters, and the like) of the electronic text and the text transcript. By aligning the electronic text with the text transcript, audio book module 12 may determine a correspondence between locations in the electronic text with locations in the text transcript, so that audio book module 12 may determine a mapping of locations in the electronic text to locations in the text transcript. Because the text transcript is produced via speech-to-text recognition of the speech contents of the audio book, audio book module 12 may, by aligning the electronic text with the text transcript, determining a mapping of locations in the electronic text to locations (e.g., timestamps) of the audio book. In this way, audio book module 12 may map organizational data such as key features of the electronic text (e.g., words, paragraphs, and chapters) and as other information to specific locations in the audio book.

Audio book module 12 may align the electronic text with the text transcript via any suitable techniques. In one example, audio book module 12 may first perform a coarse alignment and subsequently may perform a fine alignment. To perform the coarse alignment, audio book module 12 may use Hirschberg's algorithm that finds an optimal sequence alignment between strings. Audio book module 12 may use a customized word-to-word match scoring scheme with Hirschberg's algorithm to produce a globally optimal alignment. In other words, audio book module 12 may determine portions of electronic text that match portions of the text transcript. Audio book module 12 may perform post processing to group nearby alignments into clusters of audio intervals that strongly align, and may fill in alignment gaps by smoothing between known alignment points.

To perform the fine alignment, audio book module 12 may perform a forced alignment pass that aligns clusters of text and audio that audio book module 12 had previously determined as to strongly align during the coarse pass. For portions of electronic text that align well with corresponding portions of the text transcript, audio book module 12 may map key features in those portions of electronic text to the corresponding portions of the text transcript. Audio book module 12 may refrain from mapping to the text transcript key features in portions of electronic text that do not align well with portions of the text transcript.

For example, if audio book module 12 had extracted the table of contents and other key features from the electronic text, audio book module 12 may map the position of the chapters and key features of the electronic text to corresponding positions of the text transcript based on aligning the electronic text with the text transcript. Because the text transcript is a speech-to-text transcript of the audio book, positions in the text transcript may be associated with timestamps of the audio book. In this way, audio book module 12 may map the positions of chapters as well as other extracted key features of the electronic text to corresponding timestamps of the audio book.

Audio book module 12 may perform further adjusting of such mappings of key features to the audio book via heuristics such as snapping to file boundaries or to detected large silence boundaries. For example, audio book module 12 may determine that a large silence boundary is associated with a chapter boundary, and may align a chapter boundary in the electronic text with the large silence boundary. Audio book module 12 may also determine which key features are not mapped to locations within the audio book, such as when the key features are associated with misaligned or poorly aligned portions of the electronic text. By aligning the electronic text with the text transcript of the audio book, audio book module 12 may determine portions of the audio book that are aligned with portions of the electronic text, and portions of the audio book that are not aligned with portions of the electronic text.

Audio book module 12 may determine organizational data associated with the audio book based at least in part on aligning the electronic text with the text transcript of the audio book. The organizational data may include linguistic events and silence events, as well as other information such as the textual transcript of what is being spoken in the audio book, the number of works spoken in the audio book, and the like.

Linguistic events may include key features as discussed above, including chapter boundaries, paragraph boundaries, sentence boundaries, word boundaries, the table of contents, and the like. For portions of the audio book that are aligned with portions of the electronic text, audio book module 12 may determine those linguistic events from the electronic text and their associated locations within the aligned portions of the electronic book, and may map those locations within the electronic book to timestamps within the audio book. For portions of the audio book that are not aligned with portions of the electronic text, audio book module 12 may determine those linguistic events from the text transcript of the audio book or from the audio of the audio book. For example, audio book module 12 may, based at least in part on analyzing word utterances, common phrases, voice characteristics and the like in the audio of the audio book, determine linguistic events such as an introduction, a change in characters speaking, the beginning or end of a chapter, and the like.

Silence events may be events associated with silence in the audio of the audio book. Audio book module 12 may analyze the audio of the audio book to find gaps in the audio, which may be silences in the audio that may be as short as 50 milliseconds, and may associate the timestamps of those silences with silence events. Silence events may denote the nature of the silence, such as sentence-delimiting silence, intra-sentence silence, word-delimiting silence, intra-word silence, paragraph-delimiting silence, chapter-delimiting silence, and the like.

For portions of the audio book that are aligned with portions of the electronic text, audio book module 12 may infer the nature of the silence from the electronic text, create silence events in associated locations within the aligned portions of the electronic book, and map those locations within the electronic book to the timestamps of silences detected within the audio book. For portions of the audio book that are not aligned with portions of the electronic text, audio book module 12 may infer the nature of the silence from the text transcript of the audio book or from the audio of the audio book, and may create silence events associated with the timestamps of silences within those portions of the audio book.

Audio book server 4 may include an application programming interface (API) that may serve the organizational data associated with audio books to computing devices, such as computing device 2, so that computing device 2 may generate a navigational structure for playback and navigation of associated audio books, as well as to provide additional features that may improve the audio book playback and navigation functionality of computing device 2.

Computing device 2 represents one or more individual mobile or non-mobile computing devices that are configured to access audio books and organizational data associated with audio books provided by audio book server 4 via one or more networks 8. Examples of computing device 2 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or security system), a voice-interface or countertop home assistant device, a personal digital assistants (PDA), a gaming system, a media player, an e-book reader, a mobile television platform, an automobile navigation or infotainment system, or any other type of mobile, non-mobile, wearable, and non-wearable computing device configured to access audio books and organizational data associated with audio books provided by audio book server 4 via one or more networks 8, and to present and playback the audio books received from audio book server 4 based at least in part on the data associated with the audio books provided by audio book server 4 via one or more networks 8.

In the example of FIG. 1, computing device 2 may include user interface component (UIC) 14, user interface (UI) module 16, and audio book player 18. UI module 16, and audio player 18 may perform operations described using software, hardware, firmware, or a mixture of hardware, software, and firmware residing in and/or executing at computing device 2. Computing device 2 may execute UI module 16, and audio player 18 with multiple processors or multiple devices. In some cases, computing device 2 may execute UI module 16, and audio player 18 as virtual machines executing on underlying hardware. UI module 16, and audio player 18 may also execute as one or more services of an operating system or computing platform, or as one or more executable programs at an application layer of a computing platform.

UIC 14 of computing device 2 may function as an input and/or output device for computing device 2. UIC 14 may be implemented using various technologies. For instance, UIC 14 may function as an input device using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology.

UIC 14 may function as input devices using microphone technologies, infrared sensor technologies, or other input device technology for use in receiving user input. For example, UIC 14 may detect, using built-in microphone technology, voice input. As another example, UIC 14 may include a presence-sensitive display that may receive tactile input from a user of computing device 2. UIC 14 may receive indications of tactile input by detecting one or more gestures from a user (e.g., the user touching or pointing to one or more locations of UIC 14 with a finger or a stylus pen).

UIC 14 may function as output (e.g., display) device and present output to a user. UIC 14 may function as an output device using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 2. UIC 14 may function as output device using speaker technologies, haptic feedback technologies, or other output device technology for use in outputting information to a user. UIC 14 may present a user interface (e.g., user interface 16) provided by audio book player 18. UIC 14 may present a user interface related to other features of computing platforms, operating systems, applications, and/or services executing at and/or accessible from computing device 2 (e.g., e-mail, chat, online services, telephone, gaming, etc.).

UI module 16 may manage user interactions with UIC 14 and other components of computing device 2. UI module 16 and UIC 14 may receive one or more indications of input (e.g., voice input, gesture input, etc.) from a user as the user interacts with the user interface, at different times and when the user and computing device 2 are at different locations. UI module 16 and UIC 14 may interpret inputs detected at UIC 14 and may relay information about the inputs detected at UIC 14 to audio book player 18 and/or one or more other associated platforms, operating systems, applications, and/or services executing at computing device 2, for example, to cause computing device 2 to perform functions.

UI module 16 may cause UIC 14 to output, display, or otherwise present a user interface while a user of computing device 2 views output and/or provides input at UIC 14. For example, as shown in FIG. 1, UI module 16 may send instructions to UIC 14 that cause UIC 14 to display user interface 20, which is a graphical user interface (GUI), at a display screen of UIC 14. In other examples, UI module 16 may also cause UIC 14 to output a user interface in non-visual form, such as audio output. For example, if computing device 2 is an audio player device, UI module 16 may send instructions to UIC 14 that cause UIC 14 to output audio.

UI module 16 and UIC 14 may receive one or more indications of input (e.g., voice input, touch input, non-touch or presence-sensitive input, video input, audio input, etc.) from a user as the user interacts with user interface 20, at different times and when the user and computing device 2 are at different locations. UI module 16 and UIC 14 may interpret inputs detected at UIC 14 and may relay information about the inputs detected at UIC 14 to audio book player 18 and/or one or more other associated platforms, operating systems, applications, and/or services executing at computing device 2, for example, to cause computing device 2 to perform functions.

UI module 16 may receive information and instructions from one or more associated platforms, operating systems, applications, and/or services executing at computing device 2 and/or one or more remote computing systems, such as audio book server 4. For example, UI module 16 may receive information (e.g., audio data, text data, image data, etc.) and instructions for presenting as user interface 20. In the example of FIG. 1, audio book player 18 may direct UI module 16 to output, for display at a display device in UIC 14, user interface 20 of audio book player 18 and may also direct UI module 16 to output, at a sound output device in UIC 14 (e.g., loudspeakers, headphones, and the like), audio of an audio book being played by audio book player 18.

Audio book player 18 may be any application or process executing on one or more processors of computing device 2 to interact with audio book server 4 to receive audio books along with associated organizational data from audio book server 4, and to play the receive audio books. In some examples, to play an audio book, audio book player 18 may download the entire audio book and associated organizational data. In other examples, audio book player 18 may stream the audio book from audio book server 4. In this case, audio book player 18 may download a portion (e.g., less than the entirety) of an audio book at a time. In some examples, audio book player 18 may be a standalone application, or may be a web browser that accesses a web application from audio book server 4 that plays audio books.

Audio book player 18 may cause UIC 14 of computing device 2 to output user interface 20 with which the user may interact in order to control the playing of audio books. That is, audio book player 18 may send data to UI module 16 to cause UIC 14 to display user interface 20, which may be the graphical user interface of audio book player executing at computing device 2.

To playback an audio book, audio book player 18 may download at least a portion of an audio book along with organizational data associated with the audio book from audio book server 18, and may send data to UI module 16 to cause UIC 14 to output the audio of the audio book. Audio book player 18 may also utilize the organizational data to provide or augment functionality of audio book player 18 when playing the audio book, by enabling the audio book player to intelligently implement various functionalities of audio book player 18.

As discussed above, organizational data associated with an audio book may include one or more linguistic events, one or more silence events, and/or other information such as the textual transcript of what is being spoken in the audio book, the number of words spoken in the audio book, the table of contents, and the like. The one or more linguistic events may include indications of chapter boundaries, paragraph boundaries, sentence boundaries, word boundaries, and the like, as well as indications of an introduction, a change in characters speaking, the beginning or end of a chapter, and the like.

The one or more audio events may include indications of the nature of silences in the audio book, such as sentence-delimiting silence, intra-sentence silence, word-delimiting silence, intra-word silence, paragraph-delimiting silence, chapter-delimiting silence, and the like. Organizational data may include indications of timestamps at which the one or more linguistic events and the one or more silence events occur in the audio book, so that audio book player 18 may determine, based at least in part on the organizational data, when the events occur in the audio book.

User interface 20 may include user interface elements that provide information regarding the audio book as well as user interface elements that enable the user to control the playback of an audio book and enable the user to navigate around the audio book. For example, user interface 20 may include controls 21 that allow the user to control the playback of an audio book, such as fast forward, rewind, play, pause, scrubbing through the audio book, and the like.

Audio book player 18 may use the organizational data associated with the audio book to perform more intelligent control of the playback of the audio book. Audio book player 18 may use the number of words in the audio book, as indicated in the organizational data, to determine the rate of speech (e.g., number of words spoken per minute) to adjust the playback speed of the audio book based on user preferences. Audio book player 18 may also provide such information as to the rate of spoken words to the user prior to download or purchase of the audio book.

Audio book player 18 may also utilize word, sentence, and/or chapter boundaries indicated in the organizational data when pausing, fast forwarding, rewinding, skipping, or otherwise navigating around the audio book. For example, to pause the playback of the audio book, audio book player 18 may pause playback of the audio book at a timestamp associated with the closest sentence boundary or word boundary. Similarly, after fast forwarding or rewinding, the audio book player may resume playback of the audio book at the closest sentence boundary or word boundary. Audio book player 18 may also be able to skip through the audio book by paragraphs, chapters, and the like based at least in part on the indications of sentence boundaries, paragraph boundaries, and/or chapter boundaries in the organizational data.

In some examples, audio book player 18 may utilize organizational data to create and output a table of contents 22 for the audio book in user interface 20. For example, audio book player 18 may use the indication of the table of contents included in the organizational data or the indications of chapter boundaries included in the organizational data to create table of contents 22. Table of contents 22 may include links selectable by the user to jump to the portion of the audio book that corresponds to the start of the selected chapter. Besides a listing of chapters, table of contents 22 may also include other selectable links to jump to portions of the audio book, such as to locations within chapters, and the like.

In addition to table of contents 22, audio book player 18 may also output any other representations of navigational structure in user interface 20 to provide information to the user and to enable the user to navigate around the audio book. For example, audio book player 18 may utilize the organizational data to create and output footnotes, references, a glossary, and the like associated with the audio book, which may display information when selected by the user.

In another example, audio book player 18 may perform sentient analysis on the audio book to identify portions of the audio book that are associated with certain emotions or speech patterns. Alternatively, audio book player 18 may receive organizational data that includes an indication of portions of the audio book associated with emotions or speech patterns. Audio book player 18 may output in user interface 20 an indication of the portions of the audio book associated with the emotions and/or speech patterns, which may be selectable by the user to jump to the selected portions of the audio book.

In some examples, audio book player 18 may also output any appropriate information at any time in user interface 20 based at least in part on the organizational data. For example, when narrating a book, audio book player 18 may output the name of the character that is currently speaking in user interface 20. In another example, while the audio is being played, or when the audio is being fast forwarded, rewound, or being scrubbed, audio book player 18 may also output the text being currently spoken in user interface 20.

In some examples, audio book player 18 may enable bookmarks of positions in the audio book. The bookmarks may be created by the user, or may be generated automatically without user interaction by audio book player 18 (e.g., a last listened to position bookmark). In addition to determining the timestamp of the bookmarks, audio book player 18 may utilize the text transcript of the audio book included in the organizational data to create and output, in user interface 20, summaries of each of the bookmarks that may include the last set of words spoken for the bookmark.

In some examples, audio book player 18 may detect and extract entities in an audio book, such as major characters, based at least in part on the organizational data, and may output information regarding such detected entities in user interface 20. For example, audio book player 18 may determine the characters in the audio book, and may output a list of such characters as well as summaries of each of the characters.

In some examples, audio book player 18 may determine uncommon words in the audio book, such as based at least in part on the text transcript of the audio book included in the organizational data, and may display such uncommon words in the user interface 20, along with their definitions, as the audio of such words are played during playback of the audiobook.

In some examples, audio book player 18 may detect content in the audio book that is in a language different from the dominant language of the audio book. For example, audio book player 18 may detect a sentence spoken in French in an English-language audio book. Audio book player 18 may display a translation of such content as the audio of such content are played during playback of the audiobook.

Audio book player 18 may also use the organizational data to extract common story patterns for the purposes of creating extracts or abstracts of the audio book. Audio book player 18 may utilize a machine learning model trained on story structures to perform such an extraction of common story patterns.

Audio book player 18 may also enable text-based or voice-based searching of the audio book by indexing the spoken words of the audio book and storing them into a searchable graph. For example, audio book player 18 may use the text transcript of the audio book included in the organizational data to create such a searchable graph of words in the audio book.

The techniques described in the context of FIG. 1 as well as throughout the disclosure may improve the functioning of computers such as audio book server 4 and computing device 2 in a number of ways. The techniques described herein improve the functioning of audio book server 4 by enabling it to determine organizational data for audio books that do not include or were not previously associated with organizational data. Audio book server 4 may also be able to increase the amount and types of organizational data that can be associated with audio books, and may be able to determine relatively more useful organizational data for audio books.

By identifying an electronic text associated with an audio book, and by determining organizational data associated with the audio book based at least in part on the electronic text, audio book server 4 may be able to more efficiently (e.g., spend fewer processing cycles) and more quickly determine organizational data as opposed to techniques that may depend solely upon analyzing the audio book itself to determine organizational data. In addition, the techniques described herein improve the functioning of audio book server 4 by enabling it to provide (e.g., transmit) to other computing devices (e.g., computing device 2) both audio books as well as their associated organizational data.

The techniques described herein also improves the functioning of computing device 2 that includes audio book player 18 may enabling it to receive audio books along with the rich organizational data associated with the audio books. Thus, computing device 2 does not have to expend as much processing resources to determine organizational data associated with the audio books.

Moreover, the techniques described herein improves the functioning of audio book player 18 that executes at computing device 2 by enabling audio book player 18 to provide additional functionality that is made possible by the organizational data, such as adjusting the playback speed of audio books based on the organizational data, and pausing playback of audio books at the end of words or sentences based on the organizational data.

The techniques of this disclosure may also increase the ease of use of computing device 2 and audio book player 18 that executes at computing device 2. For example, audio book player 18 may be able to provide a table of contents based on the organizational data that enables the user to jump to the start of individual chapters within the audio book. Further, audio book player 18 may be able to translate words in the audio book that are in a foreign language, or provide definitions of uncommon words in the audio book, thereby increasing the ease of use of audio book player 18.

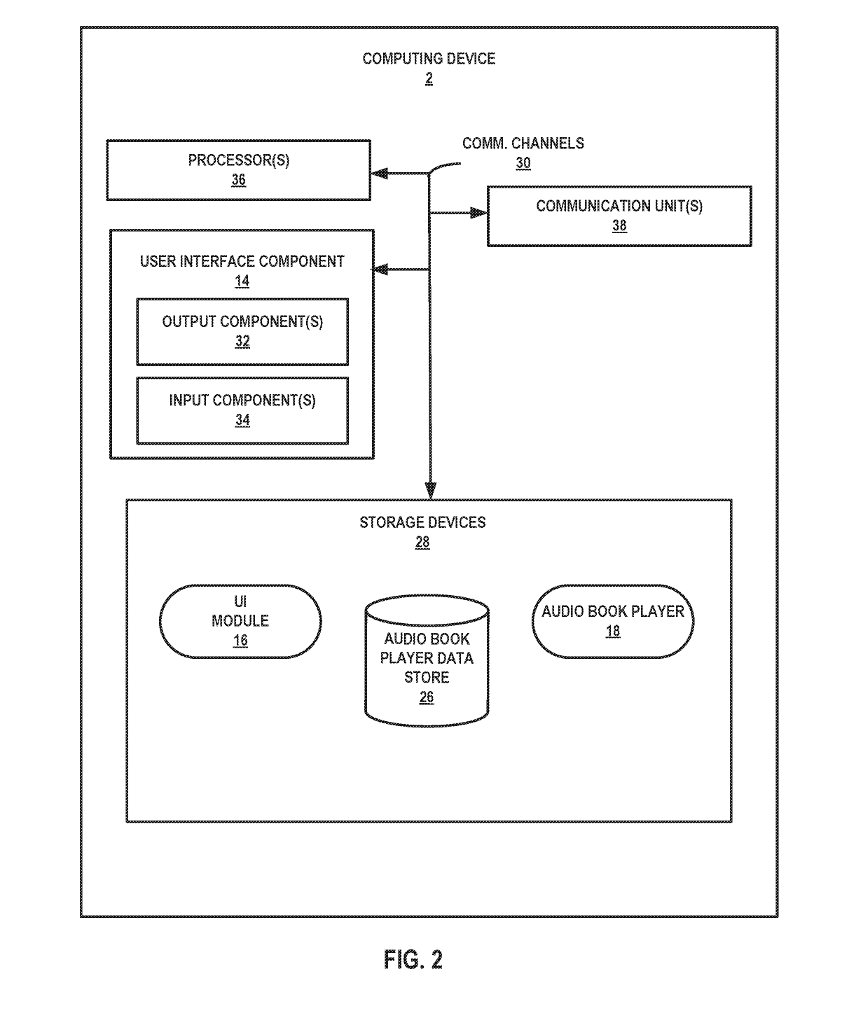

FIG. 2 is a block diagram illustrating an example computing device that is configured to receive and playback audio books, in accordance with one or more aspects of the present disclosure. FIG. 2 illustrates only one particular example of computing device 2, and many other examples of computing device 2 may be used in other instances and may include a subset of the components included in example computing device 2 or may include additional components not shown in FIG. 2.

As shown in the example of FIG. 2, computing device 2 includes user interface component (UIC) 14, one or more processors 36, one or more communication units 38, and one or more storage components 28. UIC 14 includes output component 32 and input component 34. Storage components 28 of computing device 2 include UI module 16, assistant module 18, and audio player data store 26.

Communication channels 30 may interconnect each of the components 14, 36, 38, and 28 for inter-component communications (physically, communicatively, and/or operatively). In some examples, communication channels 30 may include a system bus, a network connection, an inter-process communication data structure, or any other method for communicating data.

One or more communication units 38 of computing device 2 may communicate with external devices via one or more wired and/or wireless networks by transmitting and/or receiving network signals on the one or more networks. Examples of communication units 38 include a network interface card (e.g. such as an Ethernet card), an optical transceiver, a radio frequency transceiver, a global positioning satellite (GPS) receiver, or any other type of device that can send and/or receive information. Other examples of communication units 38 may include short wave radios, cellular data radios, wireless network radios, as well as universal serial bus (USB) controllers.

One or more input components 34 of computing device 2 may receive input. Examples of input are tactile, audio, and video input. Input components 34 of computing device 2, in one example, includes a presence-sensitive input device (e.g., a touch sensitive screen, a PSD), mouse, keyboard, voice responsive system, video camera, microphone or any other type of device for detecting input from a human or machine. In some examples, input components 34 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 32 of computing device 2 may generate output. Examples of output are tactile, audio, and video output. Output components 32 of computing device 2, in one example, includes a PSD, sound card, video graphics adapter card, speaker, cathode ray tube (CRT) monitor, liquid crystal display (LCD), or any other type of device for generating output to a human or machine.

UIC 14 may include output component 32 and input component 34. Output component 32 may be a display component, such as a screen at which information is displayed by UIC 14 and input component 34 may be a presence-sensitive input component that detects an object at and/or near output component 32. Output component 32 and input component 34 may be a speaker and microphone pair or any other combination of one or more input and output components, such as input components 34 and output components 32. In the example of FIG. 2, UIC 14 may present a user interface (such as user interface 20 of FIG. 1).

While illustrated as an internal component of computing device 2, UIC 14 may also represent an external component that shares a data path with computing device 2 for transmitting and/or receiving input and output. For instance, in one example, UIC 14 represents a built-in component of computing device 2 located within and physically connected to the external packaging of computing device 2 (e.g., a screen on a mobile phone). In another example, UIC 14 represents an external component of computing device 2 located outside and physically separated from the packaging or housing of computing device 2 (e.g., a monitor, a projector, etc. that shares a wired and/or wireless data path with computing device 2).

One or more storage components 28 within computing device 2 may store information for processing during operation of computing device 2 (e.g., computing device 2 may store data accessed by UI module 16, audio book player 18, and audio player data store 26 during execution at computing device 2). In some examples, storage component 28 is a temporary memory, meaning that a primary purpose of storage component 28 is not long-term storage. Storage components 28 on computing device 2 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 28, in some examples, also include one or more computer-readable storage media. Storage components 28 in some examples include one or more non-transitory computer-readable storage mediums. Storage components 28 may be configured to store larger amounts of information than typically stored by volatile memory. Storage components 28 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 28 may store program instructions and/or information (e.g., data) associated with UI module 16, audio book player 18, and audio player data store 26. Storage components 28 may include a memory configured to store data or other information associated with UI module 16, audio book player 18, and audio player data store 26.

One or more processors 36 may implement functionality and/or execute instructions associated with computing device 2. Examples of processors 36 include application processors, display controllers, auxiliary processors, one or more sensor hubs, and any other hardware configure to function as a processor, a processing unit, or a processing device. UI module 16 and audio book player 18 may be operable by processors 36 to perform various actions, operations, or functions of computing device 2. For example, processors 36 of computing device 2 may retrieve and execute instructions stored by storage components 28 that cause processors 36 to perform the operations of module 16 and audio book player 18. The instructions, when executed by processors 36, may cause computing device 2 to store information within storage components 28, for example, at data stores 26.

UI module 16 may manage user interactions with UIC 14 and other components of computing device 2. UI module 16 may cause UIC 14 to output a user interface as a user of computing device 2 views output and/or provides input at UIC 14.

Audio player data store 26 may be configured to store any data associated with the operations of audio book player 18. For example, audio player data store 26 may store audio books received by audio book player 18 from audio book server 4, as well as associated organizational data for those audio books. Audio player data store 26 may also store data generated by audio book player 18 during the course of its operations, including but not limited to bookmarks, last played positions, searchable graphs of text spoken in the audio books, navigational structures of the audio books, and the like. In some examples, audio player data store 26 may also buffer the audio contents of an audio book during playback by audio book player 18.

Audio book player 18 may be executed by processors 36 to perform all of the functionality described throughout this disclosure. For example, audio book player 18 may communicate with audio book server 4 via communication units 4 to receive audio books as well as their associated organizational data, and may store the received audio books and organizational data into audio player data store 26. In some examples, audio book player 18 may receive an entire audio book at once, and may perform playback of the audio book after receipt without further communications with audio book server 4. In other examples, audio book player 18 may stream an audio book from audio book server 4, so that audio book player 18 may receive a portion of the audio book at a time.

Audio book player 18 may receive organizational data associated with the audio book. Organizational data may be metadata, contextual data, and the like, and may be stored in any suitable format such as in an eXtensible Markup Language (XML) file. Organizational data associated with an audio book may include organizational data associated with locations within the audio book may be associated with organizational data. These locations within the audio book may be time-based locations, such as timestamps within the audio book (e.g., 3 minutes and 24 seconds into playback of the audio book). Organizational data associated with a time-based location may indicate information about the time-based location in the audio book, such as whether the time-based location is a word boundary, sentence boundary, or chapter boundary, the name of a character that is currently speaking at the time-based location, the word the is being spoken at the time-based location, the emotion of the speaking character at the time-based location, and the like. Thus, for example, organizational data may be a file with a list of data pairs, where each data pair includes an indication of information as well as a timestamp.

Audio book player 18 may playback an audio book by outputting the audio of the audio book to an audio output device in output components 32, and may output a user interface (e.g., user interface 20) to a display device in output components 32 to output information associated with the audio book as determined by the audio book player 18 based at least in part on the associated organizational data. Audio book player 18 may initiate playback of an audio book (e.g., via loudspeakers that are part of output components 32).

Audio book player 18 may use the organizational data associated with the audio book to perform more intelligent control of the playback of the audio book. Audio book player 18 may use the number of words in the audio book, as indicated in the organizational data, to determine the rate of speech (e.g., number of words spoken per minute) to adjust the playback speed of the audio book based on user preferences. For example, if the audio book player 18 has a large amount of words (e.g., above a threshold number of words) as indicated by the organizational data, the audio book may increase the playback speed of the audio book to increase the rate of speech. Audio book player 18 may also provide such information as to the rate of spoken words to the user prior to download or purchase of the audio book.

Audio book player 18 may also use the organizational data associated with the audio book when pausing, fast forwarding, rewinding, skipping, or otherwise navigating around the audio book. For example, to pause the playback of the audio book, audio book player 18 may pause playback of the audio book at a time-based location in the audio book with the nearest sentence boundary or word boundary, based on the time-based locations of word boundaries and/or sentence boundaries as indicated by the organizational data. Similarly, after fast forwarding or rewinding, the audio book player may resume playback of the audio book at a time-based location with the nearest sentence boundary or word boundary, based on the time-based locations of word boundaries and/or sentence boundaries as indicated by the organizational data. Audio book player 18 may also be able to skip through the audio book by paragraphs, chapters, and the like based at least in part on the indications of sentence boundaries, paragraph boundaries, and/or chapter boundaries in the organizational data.

In some examples, audio book player 18 may utilize organizational data to create and output a table of contents for the audio book. For example, audio book player 18 may use the indication of the table of contents included in the organizational data or the indications of chapter boundaries included in the organizational data to create the table of contents. The table of contents may include links selectable by the user to jump to the time-based location of the audio book that corresponds to the beginning of the selected chapter. Besides a listing of chapters, the table of contents may also include other selectable links to jump to portions of the audiobook, such as to locations within chapters, and the like.

Audio book player 18 may also output any other representations of navigational structure to provide information to the user and to enable the user to navigate around the audio book. For example, audio book player 18 may utilize the organizational data to create and output footnotes, references, a glossary, and the like associated with the audio book, which may display information when selected by the user.

In another example, audio book player 18 may perform sentiment analysis on the audio book to identify portions of the audio book that are associated with certain emotions or speech patterns. Alternatively, audio book player 18 may receive organizational data that includes an indication of portions of the audio book associated with emotions or speech patterns. Audio book player 18 may output an indication of the portions of the audio book associated with the emotions and/or speech patterns, which may be selectable by the user to jump to the selected portions of the audio book.

As audio book player 18 initiates and continues playback of the audio book, audio book player 18 may reach locations (e.g., timestamps) within the audio book that are associated with organizational data that indicates information associated with the location within the audio book. When audio book player 18, during playback of an audio book, reaches a location within the audio book that is associated with organizational data, audio book player 18 may perform an action based at least in part on the organizational data associated with the location within the audio book.

For example, if the organizational data associated with the location within the audio book indicates information regarding the location within the audio book, audio book player 18 may output, for display at a display device of output component 32, data regarding the information. For example, if the information regarding the location within the audio book may indicate the name of the character that is currently speaking, audio book player 18 may output, for display at a display device, the name of the character that is currently speaking. In another example, during playback of the audio book, or when the audiobook is being fast forwarded, rewound, or being scrubbed, audio book player 18 may also output the text being currently spoken in user interface 20.

In some examples, audio book player 18 may enable bookmarks of positions in the audio book. The bookmarks may be created by the user, or may be generated automatically without user interaction by audio book player 18 (e.g., a last listened to position bookmark). In addition to determining the timestamp of the bookmarks, audio book player 18 may utilize the text transcript of the audio book included in the organizational data to create and output summaries of each of the bookmarks that may include the last set of words spoken for the bookmark.

In some examples, audio book player 18 may detect and extract entities in an audio book, such as major characters, based at least in part on the organizational data and may output information regarding such detected entities in user interface 20. For example, audio book player 18 may determine the characters in the audio book, and may output a list of such characters as well as summaries of each of the characters.

In some examples, audio book player 18 may determine uncommon words in the audio book, such as based at least in part on the text transcript of the audio book included in the organizational data, and may display such uncommon words in the user interface 20, along with their definitions, as the audio of such words are played during playback of the audiobook.

In some examples, audio book player 18 may detect content in the audio book that is in a language different from the dominant language of the audio book. For example, audio book player 18 may detect a sentence spoken in French in an English-language audio book. Audio book player 18 may display a translation of such content as the audio of such content are played during playback of the audiobook.

Audio book player 18 may also use the organizational data to extract common story patterns for the purposes of creating extracts or abstracts of the audio book. Audio book player 18 may utilize a machine learning model trained on story structures to perform such an extraction of common story patterns.

Audio book player 18 may also enable text-based or voice-based searching of the audio book by indexing the spoken words of the audio book and storing them into a searchable graph. For example, audio book player 18 may use the text transcript of the audio book included in the organizational data to create such a searchable graph of words in the audio book, and may store a representation of the searchable graph in audio book player data store 26.

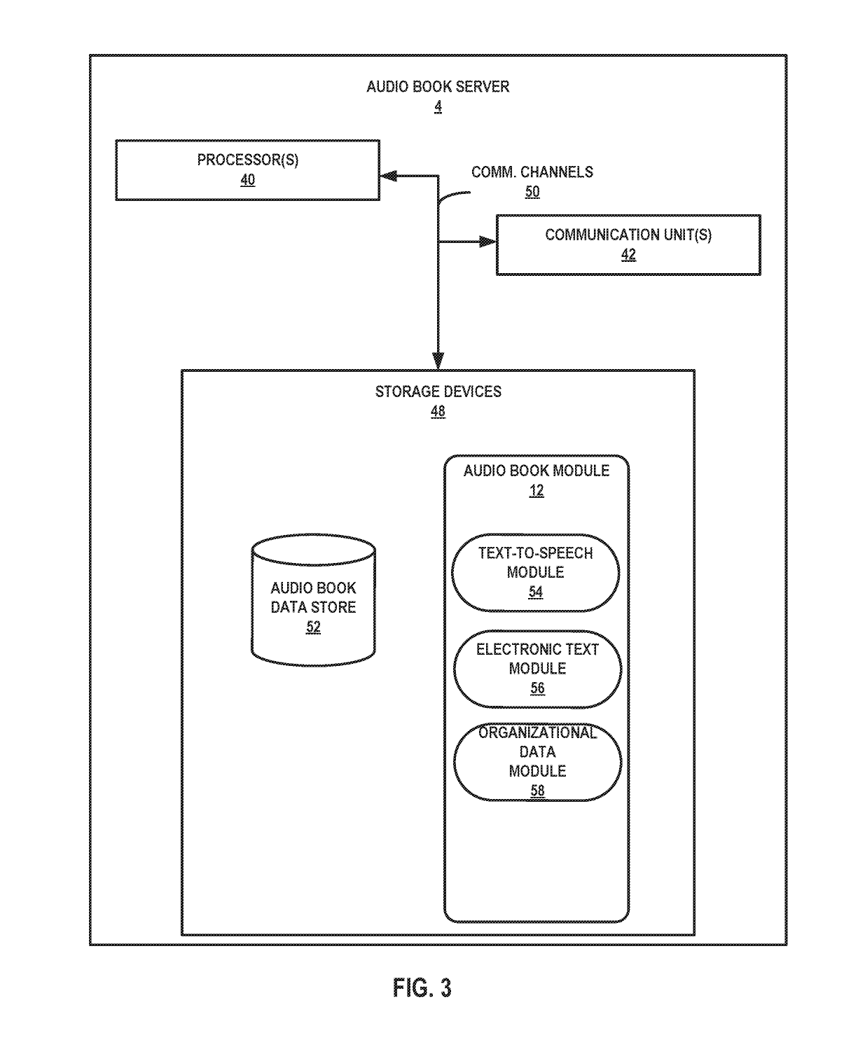

FIG. 3 is a block diagram illustrating an example audio book server, in accordance with one or more aspects of the present disclosure. FIG. 3 illustrates only one particular example of audio book server 4, and many other examples of audio book server 4 may be used in other instances and may include a subset of the components included in example audio book server 4 or may include additional components not shown in FIG. 3. For example, audio book server 4 may comprise a cluster of servers, and each of the servers comprising the cluster of servers making up audio book server 4 may include all, or some, of the components described herein in FIG. 3, to perform the techniques disclosed herein.

As shown in the example of FIG. 3, audio book server 4 includes one or more processors 40, one or more communication units 42, and one or more storage devices 48. Storage devices 48 include audio book module 12 and audio book data store 52.

Processors 40 are analogous to processors 36 of computing device 2 of FIG. 2. Communication units 42 are analogous to communication units 38 of computing device 2 of FIG. 2. Storage devices 48 are analogous to storage devices 28 of computing device 2 of FIG. 2. Communication channels 50 are analogous to communication channels 30 of computing device 2 of FIG. 2 and may therefore interconnect each of the components 40, 42, and 48 for inter-component communications. In some examples, communication channels 50 may include a system bus, a network connection, an inter-process communication data structure, or any other method for communicating data.

In some examples, storage devices 48 is a temporary memory, meaning that a primary purpose of storage devices 44 is not long-term storage. In this example, storage devices 48 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, storage devices 48 may also include one or more computer-readable storage media. Storage devices 48 in some examples include one or more non-transitory computer-readable storage mediums. Storage devices 48 may be configured to store larger amounts of information than typically stored by volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or information (e.g., data) associated with audio book module 12 and audio book data store 52. Storage devices 48 may include a memory configured to store data or other information associated with modules audio book module 12 and audio book data store 52.

Audio book data store 52 may be configured to store information received by, created by, and/or otherwise associated with audio book module 12. For example, audio book data store 52 may store audio books received by audio book module 12 from audio book source 6, electronic text received by audio book module 12 from electronic text source 13, text transcript of audio books generated by audio book module 12 as a result of performing speech-to-text recognition of audiobooks, data regarding the alignment of text transcripts to electronic texts, linguistic events and silence events extracted from audio books, and the like.

Audio book module 12 may execute at processors 40 and may be configured to determine organizational data associated with audio books. Audio book module 12 may execute on processors 40 to communicate with audio book source 6 via communication units 42 to receive audio books and may communicate with electronic text source 13 to receive electronic texts associated with audio books. Audio books module 12 may generate organizational data associated with the audio books received from audio source 6 and may transmit audio books and their associated organizational data to computing device 2 via communication units 42.

Audio book module 12 may include text-to-speech module 54 that may execute on processors 40 to perform speech recognition on audio books to generate text transcripts of audio books that are stored in audio book data store 52. Audio book module 12 may also include electronic text module 56 that may execute on processors 40 to search and/or query electronic text source 13 for electronic texts associated with audio books, receive electronic texts from electronic text source 13, and perform alignment of electronic texts with the text transcripts of corresponding audio books.

In particular, to determine an electronic text that corresponds with an audio book, electronic text module 56 may determine an electronic text out of the electronic texts in electronic text source 13 that most closely matches the text transcript of the audio book generated by text-to-speech module 54. Electronic text module 56 may determine the electronic text that most closely matches the text transcript of the audio book in any suitable fashion, such as by breaking the electronic text up into shingles and using MinHash.

Electronic text module 56 may align the electronic text with the text transcript of the audio book in order to align words within the electronic text with words in the text transcript of the audio book. Electronic text module 56 may perform a coarse alignment of the electronic text with the text transcript to determine portions of the electronic text that align well with corresponding portions of the text transcript.

To make such a determination, electronic text module 56 may utilize Hirschberg's algorithm with a customized word-to-word match scoring scheme that finds an optimal sequence alignment between strings. The result of utilizing Hirschberg's algorithm may be sets of aligned textual strings. Electronic text module 56 may perform post processing to group nearby alignments of textual strings into portions of electronic text that strongly align with corresponding portions of the text transcript, and may fill in gaps between such portions of electronic text that strongly align by smoothing between known alignment points.

Following performance of the coarse alignment, electronic text module 56 may perform a fine alignment to aligns portions of electronic text found during the coarse pass to strongly align with corresponding portions of the text transcript. Thus, electronic text module 56 may attempt to perform word-by-word alignment in the portions of electronic text found during the coarse pass to strongly align with corresponding portions of the text transcript.

Organizational data module 58 may execute on processors 40 to generate organizational data associated with audio books based at least in part on one or more of the aligned electronic texts, the text transcripts of audio books, and the audio books. Organizational data module 58 may map organizational data in those portions of electronic text to corresponding locations (e.g., corresponding words) in the corresponding portions of the text transcript. By mapping organizational data in electronic text to corresponding locations in the text transcript, organizational data module 58 may map organizational data to a plurality of time-based locations (e.g., timestamps) in the audio book.

Organizational data module 58 may generate linguistic events, silence events, and other data, associate such organizational data with a plurality of time-based locations in the audio book, and may store such organizational data in audio book data store 52. Linguistic events may include chapter boundaries, paragraph boundaries, sentence boundaries, word boundaries, the table of contents, and the like. Organizational data module 58 may analyze the electronic text to determine such linguistic events, and may associate such linguistic events with time-based locations in the audio book.

Silence events may be events associated with silence in the audio of the audio book. Organizational data module 58 may analyze the audio of the audio book to find gaps in the audio, which may be silences in the audio that may be as short as, e.g., 50 milliseconds, and may associate the time-based locations of those silences in the audio book with silence events. Silence events may denote the nature of the silence, such as sentence-delimiting silence, intra-sentence silence, word-delimiting silence, intra-word silence, paragraph-delimiting silence, chapter-delimiting silence, and the like.

Organizational data module 58 may determine the nature of the silence from the electronic text. Organizational data module 58 may be able to determine the corresponding locations of the silence events in the electronic text, and may be able to determine the nature of the silence by analyzing words, sentences, paragraphs, and the like around those corresponding locations of the silence events in the electronic text. In this way, organizational data module 58 may determine silence events that indicates the nature of silences in the audio book.

Audio book module 12 may include an API which may be accessed by computing device 2 to request audio books. In response to receiving a request for an audio book, audio book module 12 may transmit the requested audio book along with its associated organizational data to the requesting computer.

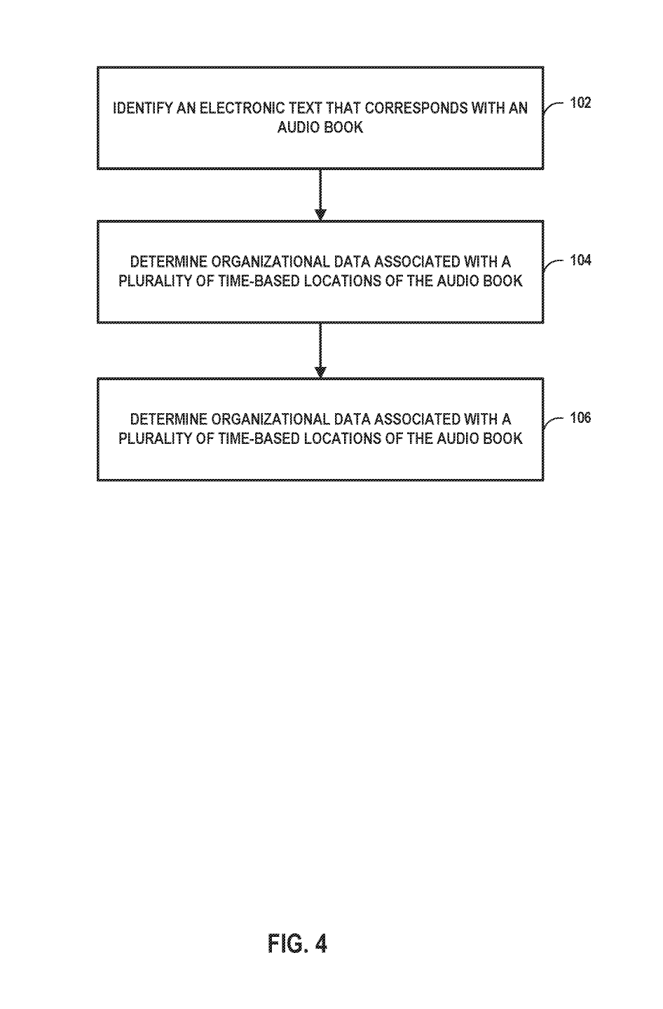

FIG. 4 is a flow diagram illustrating example operations of audio book server 4 that determines organizational data associated with audio books, in accordance with one or more techniques of the present disclosure. For purposes of illustration only, the example operations of FIG. 4 are described below within the context of FIGS. 1-3.

In the example of FIG. 4, audio book server 4 may identify, from a plurality of electronic texts in electronic text source 13, an electronic text that corresponds with an audio book (102). Audio book server 4 may determine, based at least in part on the electronic text, organizational data associated with a plurality of time-based locations of the audio book (104). Audio book server 4 may output the audio book and the organizational data to a remote computing device, such as computing device 2 (106).

In some examples, determining the organizational data associated with the audio book may further include performing speech recognition on the audio book to generate a text transcript of audio contents of the audio book, and aligning the text transcript with the electronic text to determine one or more portions of the electronic text that are aligned with corresponding portions of the text transcript, wherein the text transcript is different from the electronic text.

In some examples, audio book server 4 may further determine the organizational data from the one or more portions of the electronic text that are aligned with the corresponding portions of the text transcript. In some examples, the organizational data comprises one or more linguistic events and one or more silence events, the one or more linguistic events include one or more indications of: chapter boundaries, sentence boundaries, word boundaries, an introduction, a change in characters speaking, a beginning of a chapter, or an end of a chapter, and the one or more silence events include one or more indications of: a sentence-delimiting silence, an intra-sentence silence, a word-delimiting silence, an intra-word silence, a paragraph-delimiting silence, or a chapter-delimiting silence.

In some examples, audio book server 4 may further analyze the audio book to detect a plurality of silences, and may determine, based at least in part on the electronic text, the one or more silence events associated with one or more of the plurality of silences.

In some examples, the organizational data comprises one or more indications of the text transcript of the audio book, a number of words spoken in the audio book, or a table of contents of the audio book.

In some examples, identifying the electronic text that corresponds with the audio book may further include identifying, from the plurality of electronic texts, the electronic text that most closely matches the text transcript of audio contents of the audio book.

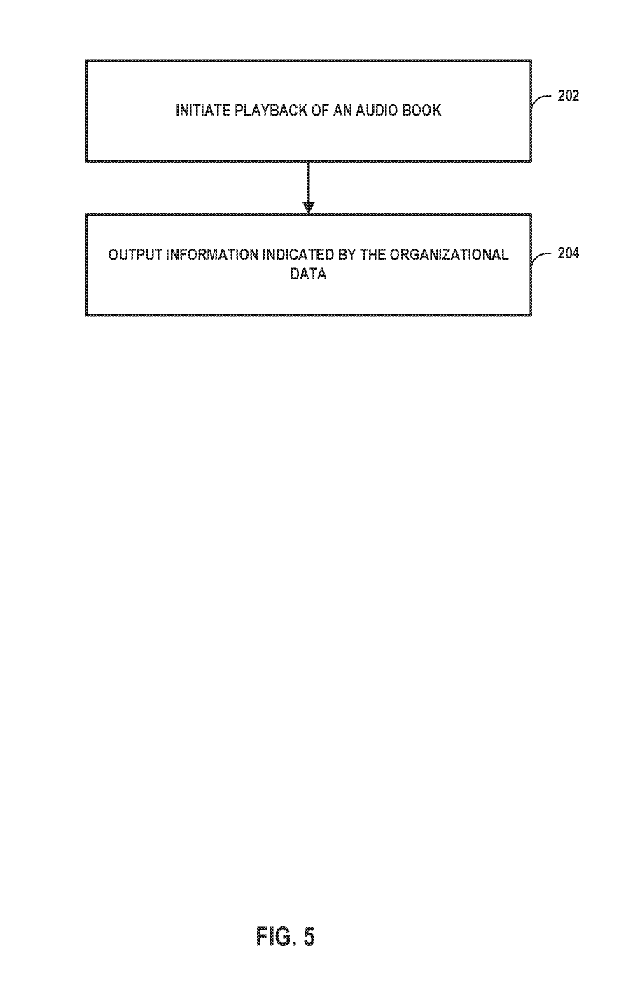

FIG. 5 is a flow diagram illustrating example operations of computing device 2 that plays audio books received from audio book server 4, in accordance with one or more techniques of the present disclosure. For purposes of illustration only, the example operations of FIG. 5 are described below within the context of FIGS. 1-3.

In the example of FIG. 5, computing device 2 may initiate playback of an audio book, wherein a plurality of time-based locations of the audio book are associated with organizational data that is determined based at least in part on an electronic text, out of a plurality of electronic texts, identified as corresponding with the audio book (202). Computing device 2 may further, responsive to the playback of the audio book reaching one of the plurality of time-based locations of the audio book associated with the organizational data, output, for display at a display device, information indicated by the organizational data (204).

In some examples, computing device 2 may further determine a rate of speech of the audio book based at least in part on a total number of words in the audio book indicated by the organizational data, and may adjust a speed of the playback the audio book based at least in part on the rate of speech of the audio book.

In some examples, responsive to receiving an indication of a command to pause the playback of the audio book, computing device 2 may pause the playback of the audio book at one of: a word boundary indicated by the organizational data, a sentence boundary indicated by the organizational data, or a chapter boundary indicated by the organizational data.

In some examples, computing device 2 may further generate a table of contents for the audio book based at least in part on chapter boundaries indicated by the organizational data, output, for display at the display device, the table of contents, receive an input indicative of a selection of a chapter in the table of contents, responsive to receiving the input, traverse to a time-based location in the audio book associated with a start of the selected chapter, and resume the playback of the audio book at the time-based location in the audio book.

In some examples, computing device 2 may create a bookmark associated with a time-based location in the audio book, determine a last set of words spoken prior to the time-based location in the audio book based at least in part on the organizational data, and output the last set of words spoken prior to the time-based location in the audio book.

In some examples, computing device 2 may create, based at least in part on the organizational data, a searchable graph of words in the audio book and associated time-based locations within the audio book, and may, responsive to receiving a query for a word, determine one or more time-based locations in the audio book associated with the word based at least in part on the searchable graph.

The following numbered examples may illustrate one or more aspects of the present disclosure:

### Example 1

A method comprising: identifying, by at least one processor and from a plurality of electronic texts, an electronic text that corresponds with an audio book; determining, by the at least one processor and based at least in part on the electronic text, organizational data associated with a plurality of time-based locations of the audio book; and outputting, by the at least one processor, the audio book and the organizational data to a remote computing device.

### Example 2

The method of Example 1, wherein determining the organizational data associated with the audio book further comprises: performing, by the at least one processor, speech recognition on the audio book to generate a text transcript of audio contents of the audio book; and aligning, by the at least one processor, the text transcript with the electronic text to determine one or more portions of the electronic text that are aligned with corresponding portions of the text transcript, wherein the text transcript is different from the electronic text.

### Example 3

The method of Example 2, further comprising: determining, by the at least one processor, the organizational data from the one or more portions of the electronic text that are aligned with the corresponding portions of the text transcript.

### Example 4

The method of Example 3, wherein: the organizational data comprises one or more linguistic events and one or more silence events; the one or more linguistic events include one or more indications of: chapter boundaries, sentence boundaries, word boundaries, an introduction, a change in characters speaking, a beginning of a chapter, or an end of a chapter; and the one or more silence events include one or more indications of: a sentence-delimiting silence, an intra-sentence silence, a word-delimiting silence, an intra-word silence, a paragraph-delimiting silence, or a chapter-delimiting silence.

### Example 5

The method of Example 4, further comprising: analyzing, by the at least one processor, the audio book to detect a plurality of silences; and determining, by the at least one processor based at least in part on the electronic text, the one or more silence events associated with one or more of the plurality of silences.

### Example 6

The method of any of Examples 1-5, wherein the organizational data comprises one or more indications of the text transcript of the audio book, a number of words spoken in the audio book, or a table of contents of the audio book.

### Example 7

The method of any of Examples 2-5, wherein identifying the electronic text that corresponds with the audio book further comprises: identifying, by the at least one processor from the plurality of electronic texts, the electronic text that most closely matches the text transcript of audio contents of the audio book.

### Example 8

A computing system comprising: a computer-readable storage medium; and at least one processor operably coupled to the computer-readable storage medium and configured to: identify, from a plurality of electronic texts, an electronic text that corresponds with an audio book; determine, based at least in part on the electronic text, organizational data associated with a plurality of time-based locations of the audio book; and output the audio book and the organizational data to a remote computing device.

### Example 9

The computing system of Example 8, wherein the at least one processor, when configured to determine the organizational data associated with the audio book, is further configured to: perform speech recognition on the audio book to generate a text transcript of audio contents of the audio book; and align the text transcript with the electronic text to determine one or more portions of the electronic text that are aligned with corresponding portions of the text transcript, wherein the text transcript is different from the electronic text.

### Example 10

The computing system of Example 9, wherein the at least one processor is further configured to: determine the organizational data from the one or more portions of the electronic text that are aligned with the corresponding portions of the text transcript.

### Example 11

The computing system of Example 10, wherein: the organizational data comprises one or more linguistic events and one or more silence events; the one or more linguistic events include one or more indications of: chapter boundaries, sentence boundaries, word boundaries, an introduction, a change in characters speaking, a beginning of a chapter, or an end of a chapter; and the one or more silence events include one or more indications of: a sentence-delimiting silence, an intra-sentence silence, a word-delimiting silence, an intra-word silence, a paragraph-delimiting silence, or a chapter-delimiting silence.

### Example 12

The computing system of Example 11, wherein the at least one processor is further configured to: analyze the audio book to detect a plurality of silences; and determine, based at least in part on the electronic text, the one or more silence events associated with one or more of the plurality of silences.

### Example 13

The computing system of any of Examples 8-12, wherein the organizational data comprises one or more indications of the text transcript of the audio book, a number of words spoken in the audio book, or a table of contents of the audio book.

### Example 14

The computing system of any of Examples 9-12, wherein the at least one processor is further configured to: identify, from the plurality of electronic texts, the electronic text that most closely matches the text transcript of audio contents of the audio book.

### Example 15

A method comprising: initiating, by at least one processor, playback of an audio book, wherein a plurality of time-based locations of the audio book are associated with organizational data that is determined based at least in part on an electronic text, out of a plurality of electronic texts, identified as corresponding with the audio book; and responsive to the playback of the audio book reaching one of the plurality of time-based locations of the audio book associated with the organizational data, outputting, by the at least one processor for display at a display device, information indicated by the organizational data.

### Example 16

The method of Example 15, further comprising: determining, by the at least one processor, a rate of speech of the audio book based at least in part on a total number of words in the audio book indicated by the organizational data; and adjusting, by the at least one processor, a speed of the playback the audio book based at least in part on the rate of speech of the audio book.

### Example 17

The method of Example 15 or 16, further comprising: responsive to receiving an indication of a command to pause the playback of the audio book, pausing, by the at least one processor, the playback of the audio book at one of: a word boundary indicated by the organizational data, a sentence boundary indicated by the organizational data, or a chapter boundary indicated by the organizational data.

### Example 18

The method of any of Examples 15-17, further comprising: generating, by the at least one processor, a table of contents for the audio book based at least in part on chapter boundaries indicated by the organizational data; outputting, by the at least one processor for display at the display device, the table of contents; receiving, by the at least one processor, an input indicative of a selection of a chapter in the table of contents; responsive to receiving the input, traversing, by the at least one processor, to a time-based location in the audio book associated with a start of the selected chapter; and resuming, by the at least one processor, the playback of the audio book at the time-based location in the audio book.

### Example 19

The method of any of Examples 15-18, further comprising: creating, by the at least one processor, a bookmark associated with a time-based location in the audio book; determining, by the at least one processor, a last set of words spoken prior to the time-based location in the audio book based at least in part on the organizational data; and outputting, by the at least one processor for display at a display device, the last set of words spoken prior to the time-based location in the audio book.

### Example 20

The method of any of Examples 15-19, further comprising: creating, by the at least one processor based at least in part on the organizational data, a searchable graph of words in the audio book and associated time-based locations within the audio book; and responsive to receiving a query for a word, determining, by the at least one processor, one or more time-based locations in the audio book associated with the word based at least in part on the searchable graph.

### Example 21

A computing system comprising means for performing the method of any of Examples 1-7 or 15-20.

### Example 22

A computer-readable storage medium storing instructions that, when executed by at least one processor, cause the at least one processor to perform the method of any of Examples 1-7 or 15-20.

### Example 23

A computing system comprising: a computer-readable storage medium; and at least one processor operably coupled to the computer-readable storage medium and configured to: initiate playback of an audio book, wherein a plurality of time-based locations of the audio book are associated with organizational data that is determined based at least in part on an electronic text, out of a plurality of electronic texts, identified as corresponding with the audio book; and responsive to the playback of the audio book reaching one of the plurality of time-based locations of the audio book associated with the organizational data, output, for display at a display device, information indicated by the organizational data.

### Example 24

The computing system of Example 23, wherein the at least one processor is further configured to perform the method of any of Examples 9-14.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
identifying, by at least one processor and from a plurality of electronic texts, an electronic text that corresponds with an audio book;
determining, by the at least one processor and based at least in part on the electronic text, organizational data associated with a plurality of time-based locations of the audio book; and
outputting, by the at least one processor, the audio book and the organizational data to a remote computing device.

2. The method of claim 1, wherein determining the organizational data associated with the audio book further comprises:
performing, by the at least one processor, speech recognition on the audio book to generate a text transcript of audio contents of the audio book; and
aligning, by the at least one processor, the text transcript with the electronic text to determine one or more portions of the electronic text that are aligned with corresponding portions of the text transcript, wherein the text transcript is different from the electronic text.

3. The method of claim 2, further comprising:
determining, by the at least one processor, the organizational data from the one or more portions of the electronic text that are aligned with the corresponding portions of the text transcript.

4. The method of claim 3, wherein:
the organizational data comprises one or more linguistic events and one or more silence events;
the one or more linguistic events include one or more indications of: chapter boundaries, sentence boundaries, word boundaries, an introduction, a change in characters speaking, a beginning of a chapter, or an end of a chapter; and
the one or more silence events include one or more indications of: a sentence-delimiting silence, an intra-sentence silence, a word-delimiting silence, an intra-word silence, a paragraph-delimiting silence, or a chapter-delimiting silence.

5. The method of claim 4, further comprising:
analyzing, by the at least one processor, the audio book to detect a plurality of silences; and
determining, by the at least one processor based at least in part on the electronic text, the one or more silence events associated with one or more of the plurality of silences.

6. The method of claim 1, wherein the organizational data comprises one or more indications of the text transcript of the audio book, a number of words spoken in the audio book, or a table of contents of the audio book.

7. The method of claim 2, wherein identifying the electronic text that corresponds with the audio book further comprises:
identifying, by the at least one processor from the plurality of electronic texts, the electronic text that most closely matches the text transcript of audio contents of the audio book.

8. A computing system comprising:
a computer-readable storage medium; and
at least one processor operably coupled to the computer-readable storage medium and configured to:
identify, from a plurality of electronic texts, an electronic text that corresponds with an audio book;
determine, based at least in part on the electronic text, organizational data associated with a plurality of time-based locations of the audio book; and
output the audio book and the organizational data to a remote computing device.

9. The computing system of claim 8, wherein the at least one processor, when configured to determine the organizational data associated with the audio book, is further configured to:
perform speech recognition on the audio book to generate a text transcript of audio contents of the audio book; and
align the text transcript with the electronic text to determine one or more portions of the electronic text that are aligned with corresponding portions of the text transcript, wherein the text transcript is different from the electronic text.

10. The computing system of claim 9, wherein the at least one processor is further configured to:
determine the organizational data from the one or more portions of the electronic text that are aligned with the corresponding portions of the text transcript.

11. The computing system of claim 10, wherein:
the organizational data comprises one or more linguistic events and one or more silence events;
the one or more linguistic events include one or more indications of: chapter boundaries, sentence boundaries, word boundaries, an introduction, a change in characters speaking, a beginning of a chapter, or an end of a chapter; and
the one or more silence events include one or more indications of: a sentence-delimiting silence, an intra-sentence silence, a word-delimiting silence, an intra-word silence, a paragraph-delimiting silence, or a chapter-delimiting silence.

12. The computing system of claim 11, wherein the at least one processor is further configured to:
analyze the audio book to detect a plurality of silences; and
determine, based at least in part on the electronic text, the one or more silence events associated with one or more of the plurality of silences.

13. The computing system of claim 8, wherein the organizational data comprises one or more indications of the text transcript of the audio book, a number of words spoken in the audio book, or a table of contents of the audio book.

14. The computing system of claim 9, wherein the at least one processor is further configured to:
identify, from the plurality of electronic texts, the electronic text that most closely matches the text transcript of audio contents of the audio book.

15. A method comprising:
initiating, by at least one processor, playback of an audio book, wherein a plurality of time-based locations of the audio book are associated with organizational data that is determined based at least in part on an electronic text, out of a plurality of electronic texts, identified as corresponding with the audio book; and
responsive to the playback of the audio book reaching one of the plurality of time-based locations of the audio book associated with the organizational data, outputting, by the at least one processor for display at a display device, information indicated by the organizational data.

16. The method of claim 15, further comprising:
determining, by the at least one processor, a rate of speech of the audio book based at least in part on a total number of words in the audio book indicated by the organizational data; and
adjusting, by the at least one processor, a speed of the playback the audio book based at least in part on the rate of speech of the audio book.

17. The method of claim 15, further comprising:
responsive to receiving an indication of a command to pause the playback of the audio book, pausing, by the at least one processor, the playback of the audio book at one of: a word boundary indicated by the organizational data, a sentence boundary indicated by the organizational data, or a chapter boundary indicated by the organizational data.

18. The method of claim 15, further comprising:
generating, by the at least one processor, a table of contents for the audio book based at least in part on chapter boundaries indicated by the organizational data;
outputting, by the at least one processor for display at the display device, the table of contents;
receiving, by the at least one processor, an input indicative of a selection of a chapter in the table of contents;
responsive to receiving the input, traversing, by the at least one processor, to a time-based location in the audio book associated with a start of the selected chapter; and
resuming, by the at least one processor, the playback of the audio book at the time-based location in the audio book.

19. The method of claim 15, further comprising:
creating, by the at least one processor, a bookmark associated with a time-based location in the audio book;
determining, by the at least one processor, a last set of words spoken prior to the time-based location in the audio book based at least in part on the organizational data; and
outputting, by the at least one processor for display at a display device, the last set of words spoken prior to the time-based location in the audio book.

20. The method of claim 15, further comprising:
creating, by the at least one processor based at least in part on the organizational data, a searchable graph of words in the audio book and associated time-based locations within the audio book; and
responsive to receiving a query for a word, determining, by the at least one processor, one or more time-based locations in the audio book associated with the word based at least in part on the searchable graph.
